(19) United States
(12) Patent Application Publication
(10) Pub. No.: US 2010/0064763 A1
(43) Pub. Date: Mar. 18, 2010

(54) WEB-BASED SYSTEM AND METHOD FOR CONFIGURING TEST EQUIPMENT

(76) Inventors: Sangram K. Gaikwad, Irvine, CA (US); David A. Sigler, Santa Ana, CA (US); Kendall N. Correll, Irvine, CA (US); Gershon Shamay, Irvine, CA (US); Lawrence Vazhapully Jacob, Lake Forest, CA (US)

Correspondence Address: CHRISTIE, PARKER & HALE, LLP, PO BOX 7068, PASADENA, CA, 91109-7068, US

(21) Appl. No.: 12/371,372

(22) Filed: Feb. 13, 2009

Related U.S. Application Data
(60) Provisional application No. 61/028,882, filed on Feb. 14, 2008.

(51) Int. Cl. G01D 18/00; G06F 15/16; G06F 1/24

(52) U.S. Cl. 73/1.01; 709/203; 713/100

(57) ABSTRACT

A web-based system and method for configuring test equipment is provided. In one aspect, the invention provides a method for configuring a test instrument, the method including receiving a first configuration file previously generated by a web server, the first configuration file including information indicative of a configuration including at least one component for the test instrument, providing a user interface enabling modification of the configuration of the at least one component and the test instrument, and generating a second configuration file including information indicative of the modified configuration.

### CROSS REFERENCE TO RELATED APPLICATIONS

The present application claims the benefit of Provisional Application No. 61/028,882, filed Feb. 14, 2008, entitled “WEB-BASED SYSTEM AND METHOD FOR CONFIGURING TEST EQUIPMENT”, the contents of which are expressly incorporated herein by reference in their entirety.

### BACKGROUND

The present invention relates generally to test equipment, and more particularly to a web-based system and method for configuring test equipment.

Test equipment is commonly used for functional test and measurement of a variety of devices in a number of different industries. The devices to be tested can include any number of electrical, mechanical or computer based systems. Circuits, circuit components, printed circuit boards are commonly tested electrical devices. Computer programs executing on various processors or state machines on programmable logic devices are some examples of computer based systems that are tested. Industries using test and measurement equipment include, for example, avionics, telecommunications, networking, semiconductors, electronic circuits, electronic design automation, radar, radio frequency (RF) communications, microwave communications, optical communications and switching systems.

Some types of test equipment are highly configurable. The configurability allows for modification of the test equipment to suit any number of applications. However, the configuration process, including both initial configuration and subsequent re-configuration, can require significant labor costs associated with the time for configuration. Often, substantial time is spent on both design and implementation of particular configurations of test equipment.

The costs and efforts to configure a test instrument can be extensive. Often such development efforts involve research and calls to vendors of components for the test instrument. Once the due diligence on components is complete, time is typically spent completing a bill of materials. In addition, time is often spent generating a wire list specifying the connections that will be made between the components. A great deal of time is then spent configuring the test instrument and its components. Once the instrument has been configured, significant time is often spent designing a graphical interface for monitoring and controlling the test instrument.

### SUMMARY

Aspects of the invention relate to a web-based system and method for configuring test equipment. In one embodiment, the invention relates to a method for configuring a test instrument, the method including receiving a first configuration file previously generated by a web server, the first configuration file including information indicative of a configuration including at least one component for the test instrument, providing a user interface enabling modification of the configuration of the at least one component and the test instrument, and generating a second configuration file including information indicative of the modified configuration.

In another embodiment, the invention relates to a method for providing information for configuring a test instrument using a web server, the method including generating a list of components for the test instrument from a component database, displaying the list of components for a user, prompting the user to select components from the list, storing information indicative of at least one component selected by the user, and generating a configuration file indicative of the at least one selected component and the test instrument.

In yet another embodiment, the invention relates to a system for configuring a test instrument, the system including a web server configured to generate a configuration file indicative of at least one component for the test instrument selected by a user, and a computer coupled to the web server by the Internet, where the computer is configured to receive the configuration file and to execute configuration software enabling a user to configure the test instrument and the at least one component, where the computer is coupled to the test instrument.

### BRIEF DESCRIPTION OF THE DRAWINGS

FIG. 1 is a block diagram of a configuration system including a web server in communication with a personal computer coupled to a test instrument in accordance with an embodiment of the present invention.

FIG. 2 is a flow chart of a general process for configuring a test instrument in accordance with an embodiment of the present invention.

FIG. 3 is a flow chart of a configuration process that can be performed by a web server in accordance with an embodiment of the present invention.

FIG. 4 is a screen shot of a graphical user interface provided in conjunction with the web server process of FIG. 3 in accordance with an embodiment of the present invention.

FIG. 5 is a block diagram illustrating the interaction of several software components executing on a test instrument in accordance with an embodiment of the present invention.

FIG. 6 is a block diagram illustrating the interaction of several software components executing on a personal computer in accordance with an embodiment of the present invention.

FIG. 7 is a flow chart of a selection process that can be executed on a test instrument in accordance with an embodiment of the present invention.

FIG. 8 is a flow chart of a process for configuring a test instrument that can be executed on the test instrument in accordance with an embodiment of the present invention.

FIG. 9 is a perspective view of a test instrument being configured manually in accordance with an embodiment of the present invention.

FIG. 10 is a flow chart of a process for monitoring and controlling a test instrument in accordance with an embodiment of the present invention.

FIG. 11 is a perspective view of an test instrument incorporating multiple switches in accordance with an embodiment of the present invention.

FIG. 12 is a screen shot of a graphical user interface that can be provided by the instrument monitor and control process of FIG. 10 in accordance with the test instrument of FIG. 11.

FIG. 13 is a flow chart illustrating a first portion of a configuration process beginning at a particular website server in accordance with one embodiment of the present invention.

FIG. 14 is a flow chart illustrating a second portion of the configuration process of FIG. 13.

### DETAILED DESCRIPTION

Turning now to the drawings, web-based systems and methods for configuring test equipment are illustrated. In several embodiments, purchasers of test instruments visit a web site where they select components for the instrument, have access to detailed information about those components and export an electronic file (e.g., a device configuration file or DCF) indicative of the selected components and their properties. In such case, the exported file is provided to the test instrument via a personal computer (PC) or another device. Application software running on either the test instrument or the PC enables the purchaser to fully configure all aspects of the components to be integrated within the test instrument. Once configuration of the components within the test instrument is complete, the configuration software for the test instrument can store the settings in an updated device configuration file (DCF). In a number of embodiments, the updated DCF includes information from which a bill of materials and a wire list can be extracted. In several embodiments, the updated DCF is provided to the web site where a purchase order for all of the specified components and associated connections can be generated from the DCF. In one embodiment, the bill of materials and/or wire list are extracted from the DCF at the web site.

In a number of embodiments, application software enabling monitoring and control of the test instrument is provided at the PC. The monitor and control software can enable real-time monitoring and control of the test equipment using a graphical user interface which graphically mirrors the components integrated into to the test instrument. In some embodiments, the graphical interface is generated from the DCF. User input to the monitoring and control software can be provided by selecting and/or clicking portions of the graphical interface which can change, for example, switch positions and connections related to components installed in the test instrument. Thus, many of the challenges to quickly implementing and configuring a test instrument are streamlined by the web site component selection utility, the configuration tools and the monitor and control software.

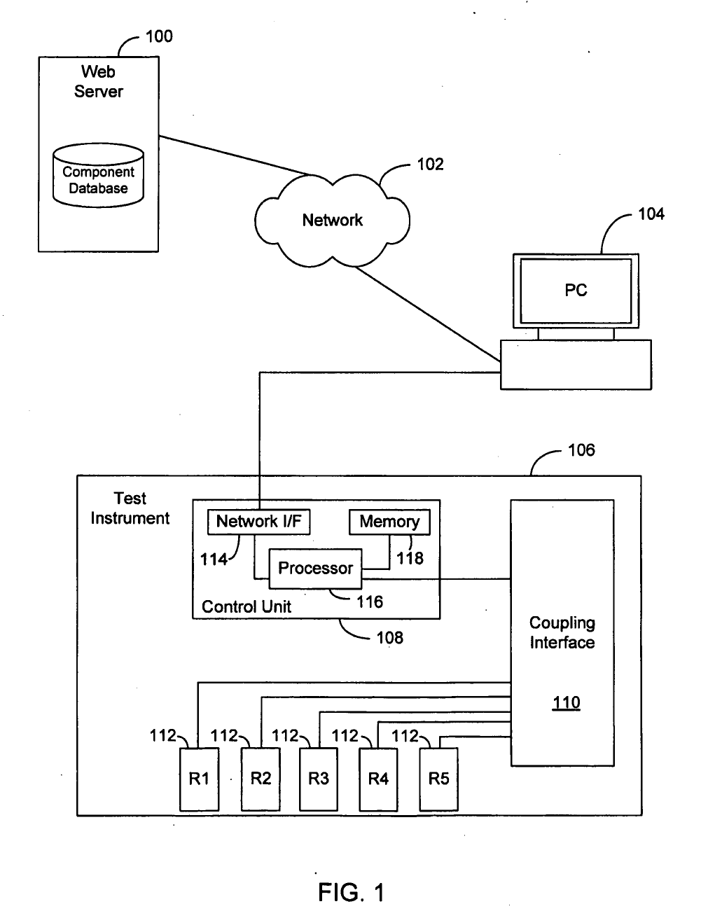

FIG. 1 is a block diagram of a configuration system including a web server 100 in communication with a personal computer (PC) 104 coupled to a test instrument 106 in accordance with an embodiment of the present invention. The web server 100, which includes a component database, is coupled to PC 104 via a network 102. The PC 104 is also coupled to the test instrument 106. The network 102 can be the Internet, a private network or any other type of network. The connection from the PC 104 to the test instrument 106 is generally an Ethernet network. In other embodiments, other methods of connection can be used to the couple the PC 104 with the test instrument 106. In some embodiments, the test instrument 106 communicates with the PC 104 via the network 102. In several embodiments, the PC 104 is remote to the test instrument 106. In one embodiment, the PC 104 can be used to configure and/or control the test instrument 106 from anywhere in the world.

The test instrument 106 includes a control unit 108 connected to a coupling interface 110 which is coupled to five relays 112. The connection from the control unit 108 to the coupling interface 110 can include any number of different channels to support a number of potential connections that can be made within the coupling interface 110. The control unit 108 includes a network interface 114 coupled to the PC 104 and a processor 116. The processor 116 is connected to a memory 118 and to the coupling interface 110. In one embodiment, the test instrument uses a MCF5272 Motorola Cold Fire processor made by Freescale Semiconductor of Austin, Tex. The network interface 114 can support any number of different network standards and protocols. The memory 118 can store instructions for operation of the processor 116.

In one embodiment, the network interface 114 provides a network interface that complies with and supports the LAN eXtensions for Instrumentation (LXI) standard (e.g., LXI Specification). The LXI standard defines devices using an open-standard local area network (LAN), currently Ethernet, for system communication between devices. The LXI standard commonly supports three function attributes including a standardized LAN interface providing web based interfacing, trigger functionality based on the IEEE 1588 standard incorporating time stamp actions within Ethernet, and a physical trigger system based on a low-voltage differential signaling (LVDS) electrical interface.

The coupling interface 110 can receive any number of digital inputs from the processor 116. Based on those digital inputs, the coupling interface can connect and drive any number of relays, switches, attenuators, amplifiers, couplers, detectors, filters, isolators, circulators, mixers, terminations, cable assemblies or other analog components. In addition, the coupling interface can connect various digital components. In some embodiments, the coupling interface can include a number of drivers for driving microwave relays. In such case, the coupling interface can be thought of as a relay driver board. In one embodiment, the relays are VTI 7122 relays available from VTI Technologies of Irvine, Calif. While five relays are included in the illustrated test instrument, any number of relays or other components can be used.

The web server 100 can be implemented using one or more servers configured to handle the volume of configuration selection requests expected for the system. The web server includes one or more component databases, including a master component database. In some embodiments, the servers are mirrored, redundant and/or fail over. In some embodiments, the web servers are connected to a number of other servers that are responsible for gathering and or maintaining the databases associated with the test instrument components and test instruments, including, for example, the master component database.

The network 102 can take on any of a variety of forms including wired and/or wireless voice and/or data networks. In many embodiments the network includes the Internet. In some embodiments, the network can be a secure or private network. In a number of embodiments, the network need only be capable of supporting basic internet communication.

The PC can be any computing type device supporting connection to the network. In some embodiments, the PC connects directly to the test instrument and thus needs appropriate hardware for connecting to the instrument. In other embodiments, the test instrument communicates with the PC via the network and thus the PC only needs to connect to the network. In one embodiment, the PC is a traditional desk top PC or laptop. In other embodiments, the PC can take different computing form factors, such as, for example a PDA, cell phone or other small computing device capable of supporting a network connection.

The test instrument can include any number of test devices. In one embodiment, the test instrument can be a test device employing use of the VXI bus, the VME bus or the LXI standard. In one embodiment, the test instrument is an RF, microwave or optical switching device. In one such case, the switching device is configured to switch broadband type signals. In several embodiments, the test instrument can be a device commonly needing significant time for configuration. In some embodiments, the test instrument is a customized test and measurement system.

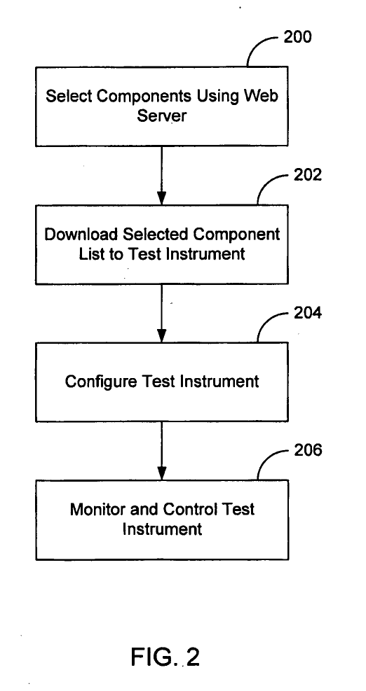

FIG. 2 is a flow chart of a general process for configuring a test instrument in accordance with an embodiment of the present invention. In particular embodiments, the process is performed in accordance with the configuration system of FIG. 1. In block 200, a user selects the desired components for a test instrument using a web server. In block 202, a list of the selected components is downloaded to the test instrument. In a number of embodiments, the downloading process is performed in conjunction with a system including a PC attached to the test instrument. In block 204, the test instrument is configured. In some embodiments, the configuration takes place using both configuration software and manual configuration. The configuration software can be executed on either the PC or the test instrument. In block 206, the test instrument is monitored and controlled using monitor and control software.

In some embodiments, not all actions described in the process are executed. For example, in one embodiment, the user does not execute the monitor and control software. In other embodiments, the actions are performed in a different order than illustrated in the flow chart. In one embodiment, some actions are performed simultaneously. For example, in one embodiment, the configuration software and monitor and control software run at the same time.

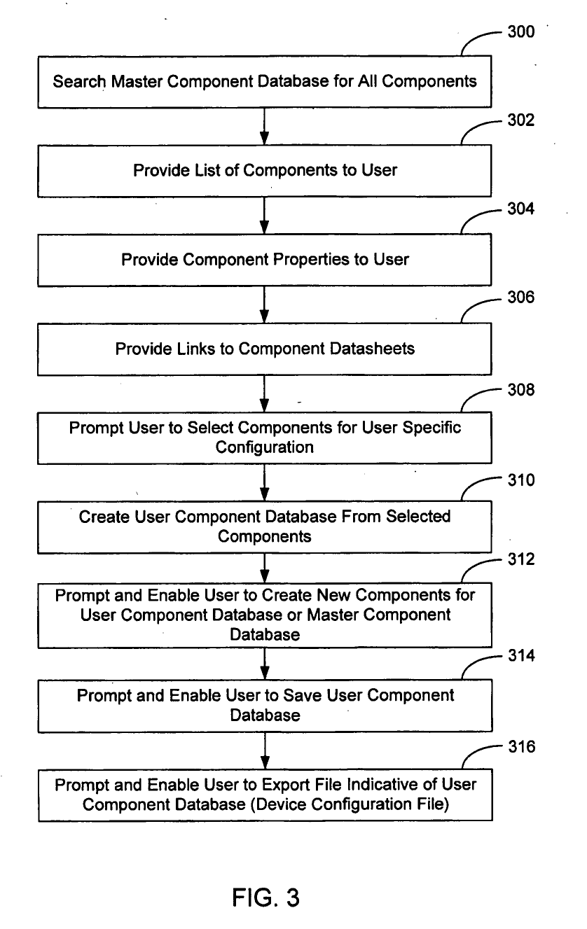

FIG. 3 is a flow chart of a configuration process that can be performed by a web server in accordance with an embodiment of the present invention. In some embodiments, the process is performed in accordance with the web server of FIG. 1. In block 300, the process searches a master component database to generate a list of all potential components for a particular test instrument. In block 302, the process provides the list of components to a user or web site visitor. In a number of embodiments, the list of components is provided graphically and may be broken up by category of device (e.g., switches, attenuators, relays, active components, passive components, etc.). In block 304, the process provides the component properties to the user. In block 306, the process provides the component properties by providing a link to a data sheet for each particular component. In some embodiments, the data sheets are not provided as they may be unavailable. In one embodiment, the process also provides technical notes, reference schematics and engineering charts and calculators useful in configuring the test instrument.

In block 308, the process prompts the user to select components for the user's specific configuration of the particular test instrument. In block 310, the process creates a user component database from the selected components by the user. In a number of embodiments, the user component database is stored on the web server as a service to the user, and can be subsequently accessed when the user returns to the web site or accesses the web server again. In block 312, the process prompts and enables the user to create new components for the user component database. In some embodiments, the process also prompts the user as to whether a newly created component should be added to the master component database for use by other users. In such case, the process can enable information sharing for mutual benefit between multiple users while protecting sensitive or proprietary user data.

In block 314, the process prompts and enables the user to save the user component database. In block 316, the process prompts and enables the user to export a file indicative of the user component data base, such as a device configuration file (DCF). In a number of embodiments, the device configuration file is formatted to be read by the test instrument and/or test instrument configuration software. In some embodiments, the DCF can contain a variety of information tailored for the test instrument and the selected components. In one embodiment, the DCF contains a number of tables having records indicative of different components along with their associated properties. In several embodiments, the DCF contains information that can be used to generate a bill of materials or a wire list. In many embodiments, the DCF is a proprietary file format and not an industry standard.

In some embodiments, not all actions described in the process are executed. For example, in one embodiment, the process does not provide component properties to the user unless the user specifies. In other embodiments, the actions are performed in a different order than illustrated in the flow chart. In one embodiment, some actions are performed simultaneously. In a number of embodiments, the actions performed by the process are performed using multiple graphical user interfaces suitable for presenting information to the user and for receiving user input.

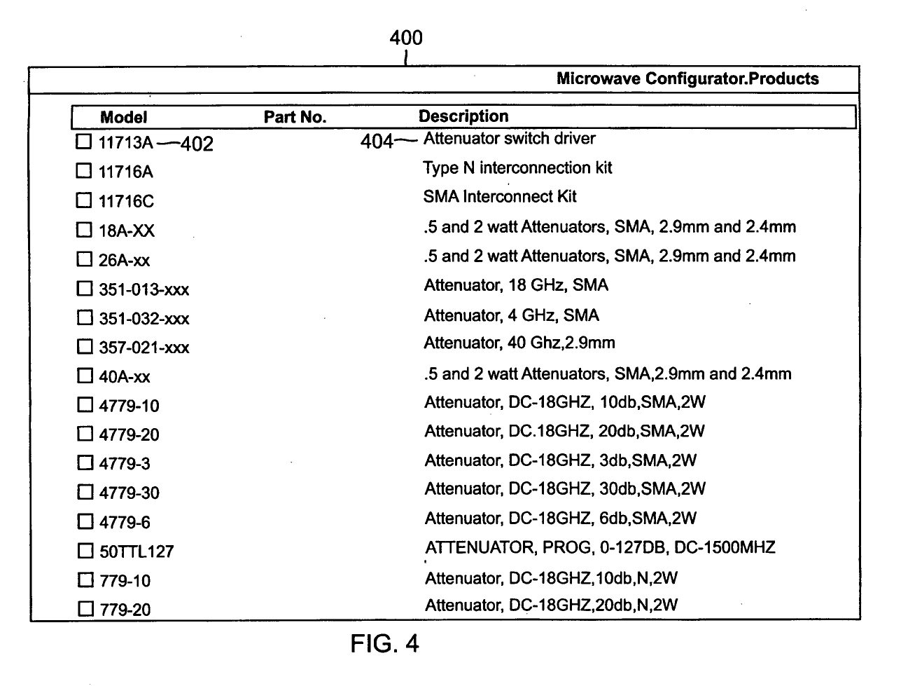

FIG. 4 is a screen shot of a graphical user interface 400 provided in conjunction with the web server process of FIG. 3 in accordance with an embodiment of the present invention. The graphical user interface 400 includes a list of components where each listed component includes a model number 402 and a description 404. In one embodiment, the user can click on the model number to download the data sheet for the specified component from the vendor of the component.

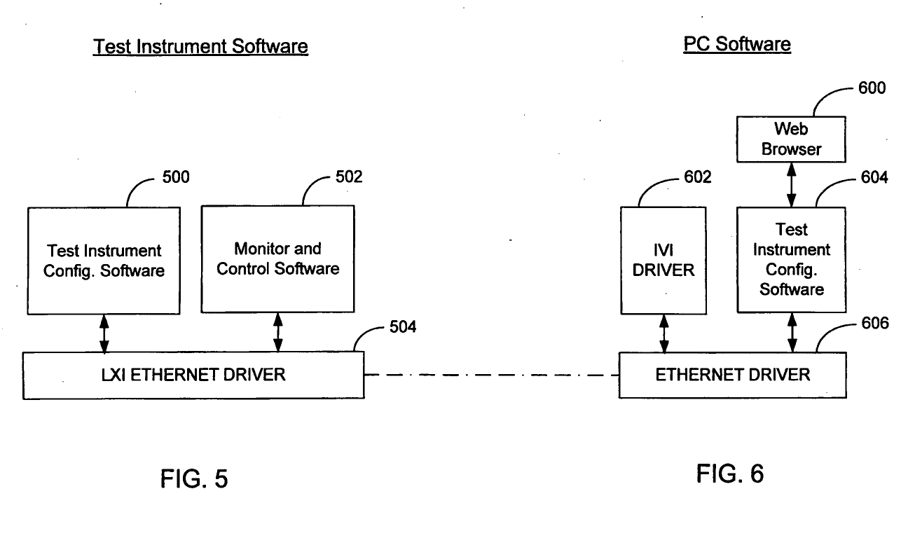

FIG. 5 is a block diagram illustrating the interaction of several software components executing on a test instrument in accordance with an embodiment of the present invention. At a lower logical level, the test instrument includes a LXI Ethernet driver 504 supporting communication to hardware including, for example, a processor or other programmable logic devices within the test instrument. The LXI Ethernet driver 504 provides communication services to several software components residing logically above the LXI Ethernet driver. Test instrument configuration software 500 uses the LXI Ethernet driver 504 to provide configuration services to the user of the test instrument and configuration system. In some embodiments, the test instrument configuration software can be executed on a PC.

Monitor and control software 502 uses the LXI Ethernet driver to provide monitoring and control services to the user. The LXI Ethernet driver 504 is logically connected to the corresponding Ethernet driver in the PC coupled to the test instrument. In a number of embodiments, each software component in FIG. 5 can be accessed and/or executed by a PC. In such case, the components are generally provided via a web browser running on the PC.

FIG. 6 is a block diagram illustrating the interaction of several software components executing on a personal computer in accordance with an embodiment of the present invention. At the logical bottom layer, an Ethernet driver 606 provides standard network services to various PC applications. Test instrument configuration software 604 uses the Ethernet driver 606 to communicate with and configure a test instrument. Web browser software 600 uses the test instrument configuration software 604 to provide a user interface enabling the user to communicate with and configure the test instrument.

An IVI driver 602 provides a standard application programming interface to other test and measurement applications (not shown) that would interface with the test instrument. The IVI driver supports the IVI standard which defines an open driver architecture enabling some level of instrument interchangeability between applications. The WI standard defines both a standard application programming interface and various simulation capabilities.

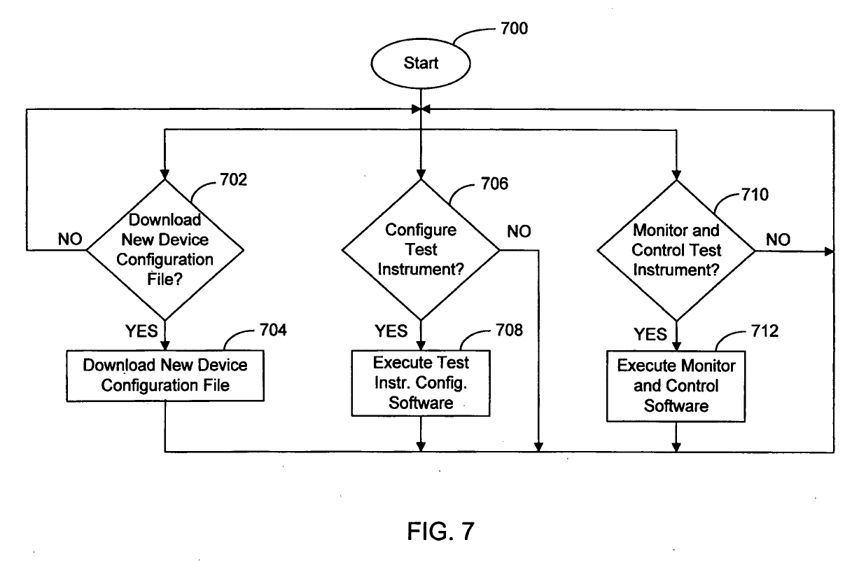

FIG. 7 is a flow chart of a selection process that can be executed on a test instrument in accordance with an embodiment of the present invention. In some embodiments, the process can be executed in accordance with the test instrument of FIG. 1. The selection process begins 700 by determining whether a user would like to download (702) a new device configuration file. If the process determines that user would like to download (702) a new device configuration file, then the process prompts the user and downloads (704) the new DCF. If not, then the process returns. If the process determines that the user would like to configure (706) the test instrument, the process executes (708) the test instrument configuration software. If not, the process returns. If the process determines that the user would like to monitor (710) and control the test instrument, then the process executes (712) the monitor and control test software. If not, the process returns. In other embodiments, these choices can be modified and/or additional choices are provided to the user.

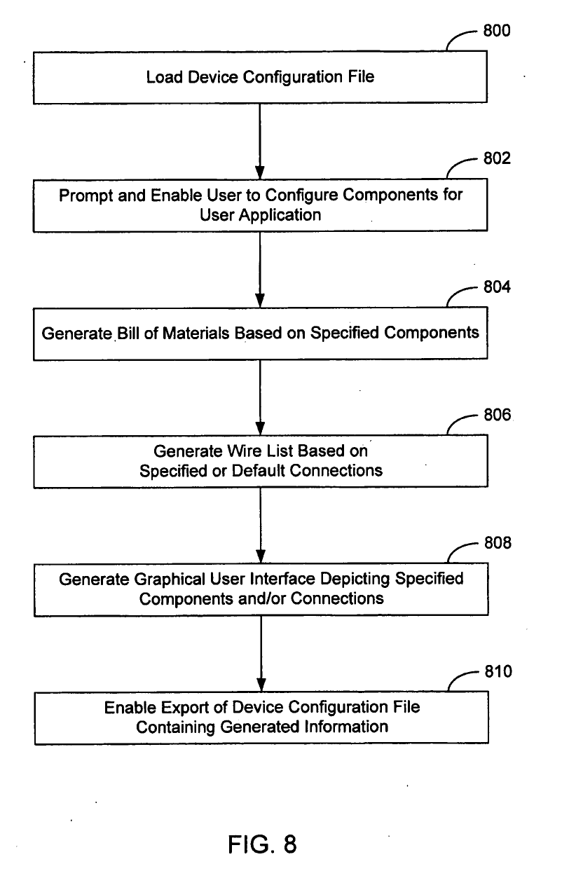

FIG. 8 is a flow chart of a process for configuring a test instrument that can be executed on a test instrument in accordance with an embodiment of the present invention. In particular embodiments, the process can be executed in accordance with the test instrument of FIG. 1. In block 800, the process loads a device configuration file. In some embodiments, the process prompts the user to provide a new DCF. In other embodiments, the process retrieves the DCF from a memory. In block 802, the process prompts and enables the user to configure the components loaded from the DCF for the user's particular test instrument application. In a number of embodiments, the user manually configures the test instrument in conjunction with the process. In some embodiments, for example, the user can rename components to reflect reference designator names from a particular schematic, create wire node names, assign logical and path names or input and output names used for path level switching. In one embodiment, for example, the user can configure relay attributes such as voltage/current capacity, latching or non-latching functionality, and odometers or cycle counts. In one embodiment, the user can save the configuration to non-volatile memory in the test instrument and create automatic power-up and shutdown states, track relay closures to assist in preventative maintenance, and generate scan lists to reduce test execution times.

In block 804, the process generates a bill of materials (BOM) based on the specified components. In many embodiments, the BOM includes all of the components or hardware that is meant to be included in a finished test instrument assembly. In some embodiments, the user instructs the process to generate the BOM. In block 806, the process generates a wire list based on the connections specified between components or based on default connections expected based on the components selected. In some embodiments, the user instructs the process to generate the wire list. In a number of embodiments, the wire list is a list defining all wires and point to point connections required to build the finished test instrument assembly.

In block 808, the process generates a graphical user interface (GUI) depicting the specified components and/or the connections between the components. In some embodiments, the GUI reflects the physical arrangement of the components within the test instrument. In block 810, the process enables the exportation of a new device configuration file containing the modified or newly generated information provided by the process. In a number of embodiments, the BOM and wire list can be extracted from the new DCF. In some embodiments, the DCF file is stored in non-volatile memory located within the test instrument. In such case, documentation relative to the test instrument is stored on the test instrument itself. In a number of embodiments, this documentation can include not only the components but data sheets and other information pertinent to each component.

In some embodiments, not all actions described in the process are executed. In other embodiments, the actions are performed in a different order than illustrated in the flow chart. In some embodiments, some actions are performed simultaneously.

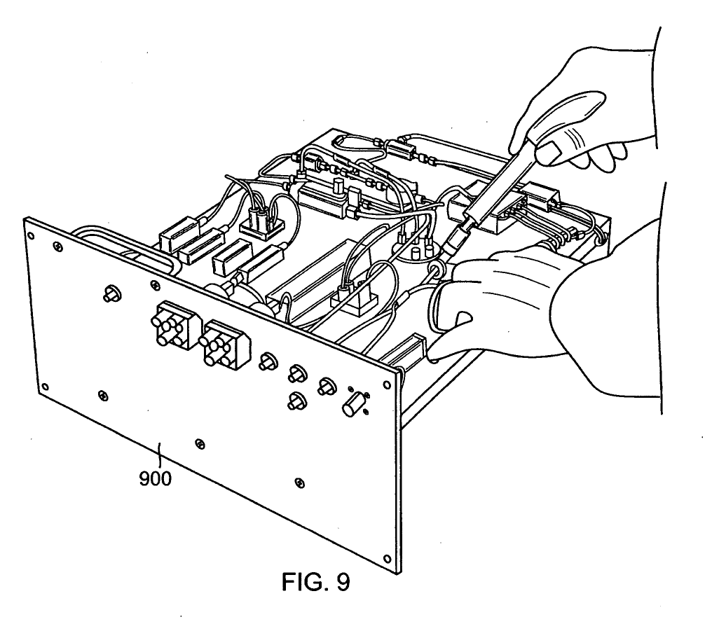

FIG. 9 is a perspective view of a test instrument 900 being configured manually in accordance with an embodiment of the present invention. In the illustrated embodiment, the test instrument 900 has the cover removed and a user is manually configuring various components.

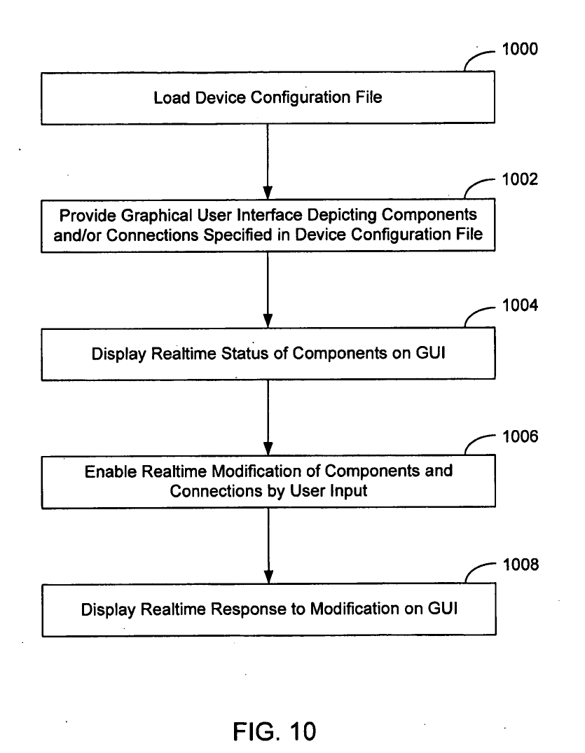

FIG. 10 is a flow chart of a process for monitoring and controlling a test instrument in accordance with an embodiment of the present invention. In some embodiments, the process can be executed in accordance with the test instrument of FIG. 1. In block 1000, the process loads a device configuration file. In some embodiments, the process prompts the user to provide a new DCF. In other embodiments, the process retrieves the DCF from a memory. In block 1002, the process provides a graphical user interface depicting components and/or connections specified in the DCF. In a number of embodiments, the GUI reflects the specified components and the physical arrangement of the components within the test instrument. In other embodiments, the GUI does not reflect the physical arrangement of the components within the test instrument.

In block 1004, the process displays real-time status of the components of the test instrument on the GUI. In block 1006, the process enables real-time modification of components and connections by user input. In some embodiments, the user input includes pointing and clicking a mouse or various keyboard input. In block 1008, the process displays the real-time results of user modification of the test instrument on the GUI. In one embodiment, the real-time results or response is indicative of a characteristic response of the test instrument. In one such case, for example, the user enters information requesting modification of the position of a switch, and the response includes changing a visual depiction of the switch to indicate the new position. In a number of embodiments, the actions performed by the process and test instrument are provided graphically. In some embodiments, this process is executed on the test instrument. In a number of such cases, the process is executed on the test instrument but receives user input via a web browser operating on a PC. In such case, no software other than a web browser is required to access and configure the test instrument, and a field technician, for example, can access and control the box simply with a laptop having a standard Ethernet interface. In other embodiments, this process is executed on a PC.

In some embodiments, not all actions described in the process are executed. In other embodiments, the actions are performed in a different order than illustrated in the flow chart. In some embodiments, some actions are performed simultaneously. In some embodiments, the process performs additional steps providing other functionality.

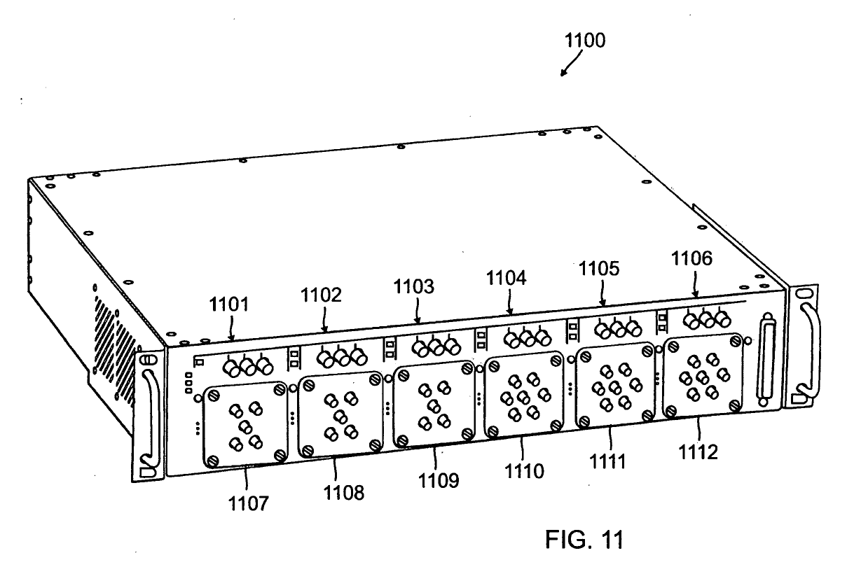

FIG. 11 is a perspective view of an test instrument 1100 incorporating multiple switches in accordance with an embodiment of the present invention. The test instrument includes six switches having three contacts ((1101 to 1106), three switches having five contacts (1107, 1108, 1109), and three switches having seven contacts (1110, 1111, 1112). The contacts for each switch are arranged in specific physical arrangements to one another. In one embodiment, the test instrument is a EX72SF microwave switching test instrument made by VTI Instruments Corporation of Irvine, Calif. In such case, the switches can be multi-throw and SPDT 26.5 GHz relays.

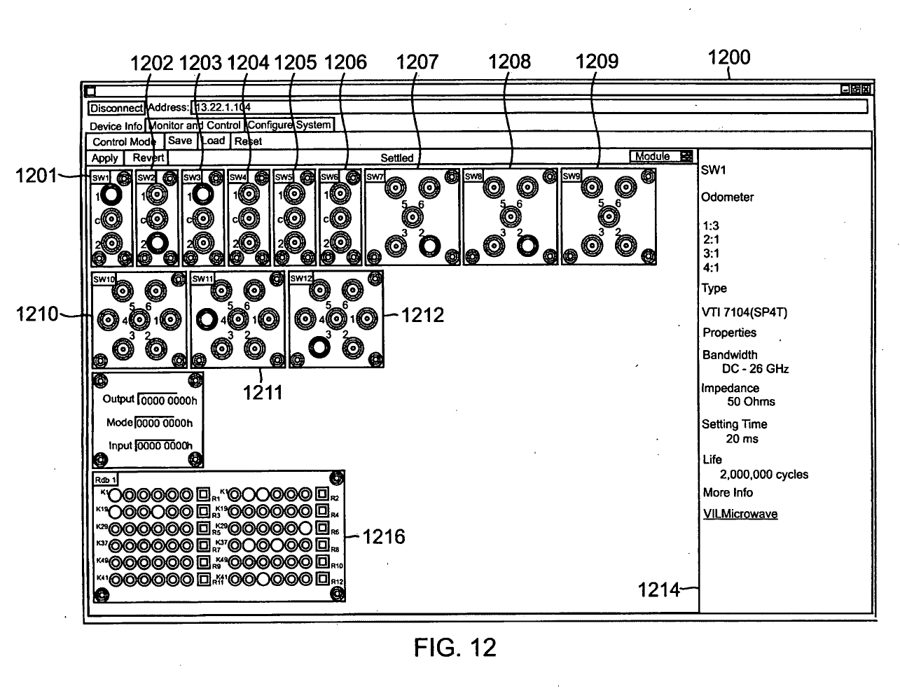

FIG. 12 is a screen shot of a graphical user interface 1200 that can be provided by the instrument monitor and control process of FIG. 10 in accordance with the test instrument of FIG. 11. The GUI includes six blocks (1201 to 1206) representing switches 1101 to 1106. The GUI further includes blocks 1207, 1208 and 1209 representing switches 1107, 1108 and 1109. The GUI further includes blocks 1210, 1211 and 1212 representing switches 1110, 1111 and 1112. Each block visually depicts the associated switch as it appears on the test instrument. More specifically, the blocks each include the switch contacts in the physical arrangement depicted on the test instrument. By pointing and clicking a mouse, the user can modify logical connections with the test instrument. An additional box display 1214 can indicate the properties of a selected component depicted on the GUI. The GUI also includes a box 1216 depicting connections made on a coupling interface (not visible in FIG. 11) such as a relay driver board.

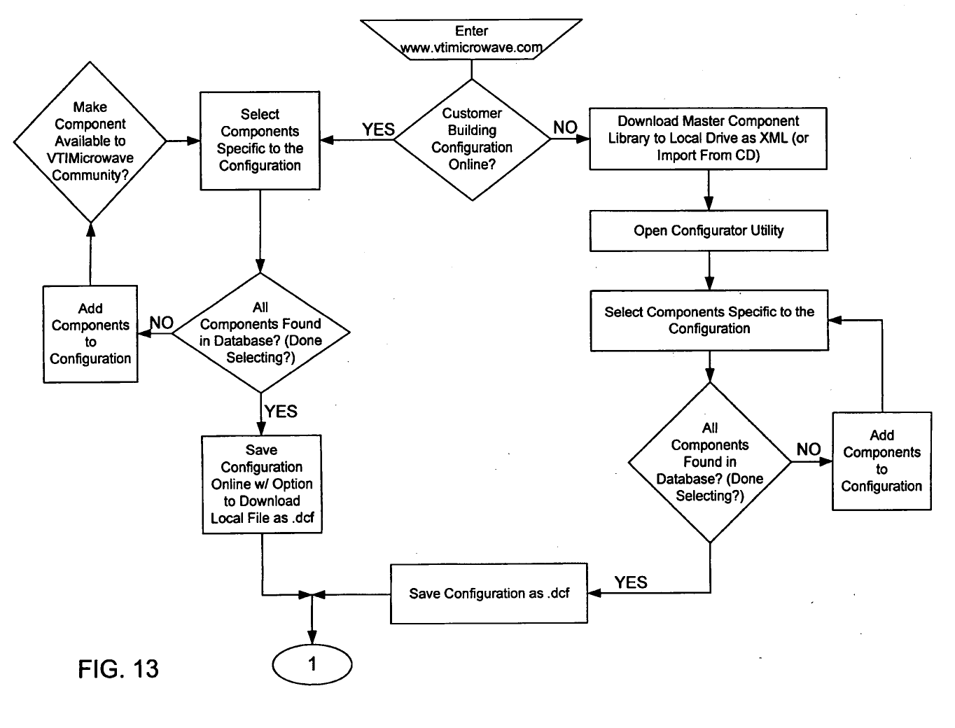

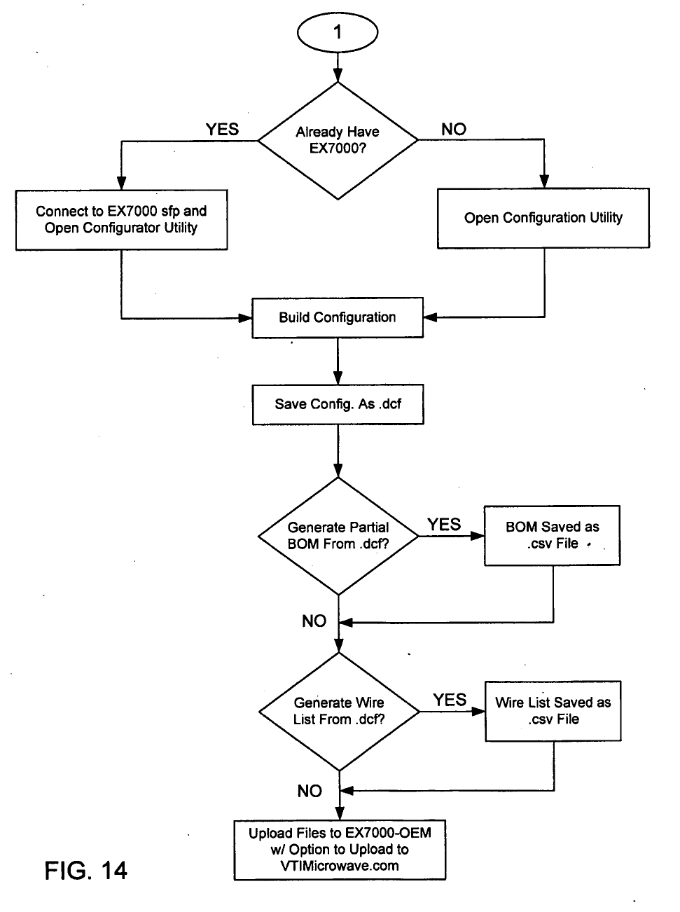

FIG. 13 is a partial flow chart illustrating a first portion of a configuration process beginning at a particular website server in accordance with one embodiment of the present invention. FIG. 14 is a partial flow chart illustrating a second portion of the configuration process of FIG. 13.

The invention therefore provides a web-based system and method for configuring test equipment. While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A method for configuring a test instrument, the method comprising:
receiving a first configuration file previously generated by a web server, the first configuration file comprising information indicative of a configuration including at least one component for the test instrument;
providing a user interface enabling modification of the configuration of the at least one component and the test instrument; and
generating a second configuration file comprising information indicative of the modified configuration.

2. The method of claim 1, further comprising generating a bill of materials for the including the at least one component.

3. The method of claim 1, further comprising generating a wire list including at least one description of a connection between the at least one component and the test instrument.

4. The method of claim 1:
wherein the test instrument is configured to operate using radio frequency; and
wherein the at least one component is configured to operate using radio frequency.

5. The method of claim 4, wherein the at least one component is any one of a switch, an attenuator, and a splitter.

6. The method of claim 1, wherein the providing the user interface enabling modification of the configuration of the at least one component and the test instrument comprises providing the user interface enabling modification of the configuration of the at least one component and the test instrument using a software driver configured to support a plurality of test instruments including the test instrument.

7. The method of claim 1, further comprising:
providing a graphical user interface depicting a representation of a physical appearance of the at least one component, wherein the graphical user interface is based on the first configuration file; and
displaying a real-time status of the at least one component on the graphical user interface.

8. The method of claim 7, further comprising:
receiving user input indicative of a request for real-time modification of the at least one component; and
displaying on the graphical user interface a real-time response to the modification, wherein the response is indicative of a characteristic response of the test instrument.

9. A method for providing information for configuring a test instrument using a web server, the method comprising:
generating a list of components for the test instrument from a component database;
displaying the list of components for a user;
prompting the user to select components from the list;
storing information indicative of at least one component selected by the user; and
generating a configuration file indicative of the at least one selected component and the test instrument.

10. The method of claim 9, further comprising:
prompting the user to define a new component not found in the component database;
storing the user defined component in a user defined component database;
prompting the user to indicate whether to make the user defined component available to other users; and
making, if the user has so indicated, the user defined component available to the other users.

11. The method of claim 9, further comprising:
receiving a second configuration file indicative of a modified configuration including the at least one second component to be used with the test instrument; and
generating a purchase order for the at least one component to be used with the test instrument.

12. The method of claim 9, further comprising:
generating, based on the configuration file, a bill of materials for the including the at least one component;
generating, based on the configuration file, a wire list including at least one description of a connection between the at least one component and the test instrument; and
generating a purchase order based on the configuration file.

13. A system for configuring a test instrument, the system comprising:
a web server configured to generate a configuration file indicative of at least one component for the test instrument selected by a user; and
a computer coupled to the web server by the Internet, wherein the computer is configured to receive the configuration file and to execute configuration software enabling a user to configure the test instrument and the at least one component;
wherein the computer is coupled to the test instrument.

14. The system of claim 13:
wherein the computer is configured to:
provide a user interface enabling configuration of the at least one component and the test instrument; and
generate a second configuration file comprising information indicative of the at least one component and the test instrument.

15. The system of claim 14, wherein the computer is configured to provide the user interface enabling configuration of the at least one component and the test instrument using a software driver configured to support a plurality of test instruments including the test instrument.

16. The system of claim 15, wherein the software driver complies with the LXI Specification.

17. The system of claim 13:
wherein the computer is configured to:
generate, based on the configuration file, a bill of materials for the including the at least one component;
generate, based on the configuration file, a wire list including at least one description of a connection between the at least one component and the test instrument;
wherein the web server is configured to generate a purchase order based on the configuration file.

18. The system of claim 13:
wherein the test instrument is configured to operate using radio frequency; and
wherein the at least one component is configured to operate using radio frequency.

19. The system of claim 13:
wherein the computer is configured to:
provide a graphical user interface depicting a representation of a physical appearance of the at least one component, wherein the graphical user interface is based on the first configuration file;
display a real-time status of the at least one component on the graphical user interface;
receive user input indicative of a request for real-time modification of the at least one component; and
display on the graphical user interface a real-time response to the modification, wherein the response is indicative of a characteristic response of the test instrument.

20. The system of claim 13:
wherein the web server is configured to:
generate a list of components for the test instrument from a component database;
display the list of components for the user;
prompt the user to select components from the list;
store information indicative of at least one component selected by the user; and
generate a configuration file indicative of the at least one selected component and the test instrument.

21. The system of claim 13:
wherein the web server is configured to:
prompt the user to define a new component not found in a component database;
store the user defined component in a user defined component database;
prompt the user to indicate whether to make the user defined component available to other users; and
provide, if the user has so indicated, the user defined component to the other users.
